(19) United States
(12) Patent Application Publication
(10) Pub. No.: US 2019/0018433 A1
(43) Pub. Date: Jan. 17, 2019

(54) BATHTUB WITH WATER USE INDICATOR AND LIMITER

(71) Applicant: BADER SHAFAQA AL-ANZI, Abdullah Al-Mubarak (KW)

(72) Inventor: BADER SHAFAQA AL-ANZI, Abdullah Al-Mubarak (KW)

(21) Appl. No.: 15/646,194

(22) Filed: Jul. 11, 2017

(51) Int. Cl. G05D 9/12; E03C 1/14; G01F 23/30; G01D 7/00

(52) U.S. Cl. CPC G05D 9/12; E03C 1/14; F16K 31/02; G01D 7/005; G01F 23/30

(57) ABSTRACT

The water conservation system for limiting water consumption during showering, the consumption levels being determined based on accepted international consumption standards. The system features a layered/hollow bathtub designed to include: a floatable, manual indicator; a sensor positioned in the bathtub's vertical wall; a reservoir for collecting water; and a waste water drainage outlet. Three different colors (red, yellow, and green) are associated with the floatable indicator to indicate the amount of water consumed during showering. An optional controlling valve automatically shuts off water flow, if the consumption rate is too high.

### BACKGROUND OF THE INVENTION

### 1. Field of the Invention

The present invention relates generally to water flow control. More specifically, the invention is a water conservation system for limiting water consumption during showering.

### 2. Description of the Related Art

Scarcity of water resources has forced people and researchers to seek other ways and alternatives to reduce water consumption for sustainability. Several devices have been made for such purpose, for example the newly developed faucet/tap with sensors has significantly reduced water consumption. Despite water shortage and limited resources in GCC region, the water consumption is the highest in the world and this is due to many reasons one of them is the subsidy of water and electricity. New trend is to raise water and electricity prices, which reflect on per capita consumption.

Of particular interest is the U.S. Pat. No. 5,206,963, issued to Wiens, which discloses a method of and system for saving water while showering. The system, designed with the capability of recirculating the water includes among its many components, a showerhead 22b, a wastewater outlet, water sensors 70 and 72, and a water consumption control means that interrupts water inflow from the showerhead when predefined conditions exist.

Of further interest is the Korean patent document 10-2009-0122788, which relates to a system for use with a showerhead for automatically controlling water flow through the head. The system is configured and arranged to include a valve, a digital key, a sensor, a detection unit showing the amount of water used, and a controller for opening and closing the valve based on a signal received from a receiver that is part of the system. See the machine generated translation available under the “Description” tab.

Furthermore, the U.S. Pat. No. 5,517,174, issued to Barrows, shows the design and construction of a sensor 10 for use in measuring water displacement. In one aspect, the sensor can be used in a bathtub to not only detect the entrance of a person into the tub, but also to detect if the water rises above a certain level, in which case an alarm is sounded.

Thus, a water conservation system for limiting water consumption during to showering solving the aforementioned problems is desired.

### SUMMARY OF THE INVENTION

The water conservation system for limiting water consumption during showering, the consumption levels being determined based on accepted international consumption standards. The system features a layered/hollow bathtub designed to include: a floatable, manual indicator, a sensor positioned in the bathtub's vertical wall; a reservoir for collecting water; and a waste water drainage outlet. Three different colors (red, yellow, and green) are associated with the floatable indicator to indicate the amount of water consumed during showering.

Numerous embodiments are described herein. One embodiment comprises a layered/hollow bathtub designed to include a floatable, manual indicator, a reservoir for collecting water; and a waste water drainage outlet. Three different colors (red, yellow, and green) are associated with the floatable indicator to indicate the amount of water consumed during showering. Another embodiment comprises a digital indicator or sensor positioned in the bathtub's vertical wall. Yet another embodiment comprises controlling valve automatically shuts off water flow, if the consumption rate is too high.

These and other features of the present invention will become readily apparent upon further review of the following specification and drawings.

### BRIEF DESCRIPTION OF THE DRAWINGS

FIG. 1 is an environmental, perspective view of a first embodiment of the water conservation system for limiting water consumption during showering according to the present invention.

FIG. 2 is an environmental, perspective view of the water conservation system for limiting water consumption during showering according to the present invention, showing the floatable, manual indicator parts.

FIG. 3 is an environmental, perspective view of a second embodiment of the water conservation system for limiting water consumption during showering according to the present invention, showing the digital indicator.

Similar reference characters denote corresponding features consistently throughout the attached drawings.

### DETAILED DESCRIPTION OF THE PREFERRED EMBODIMENTS

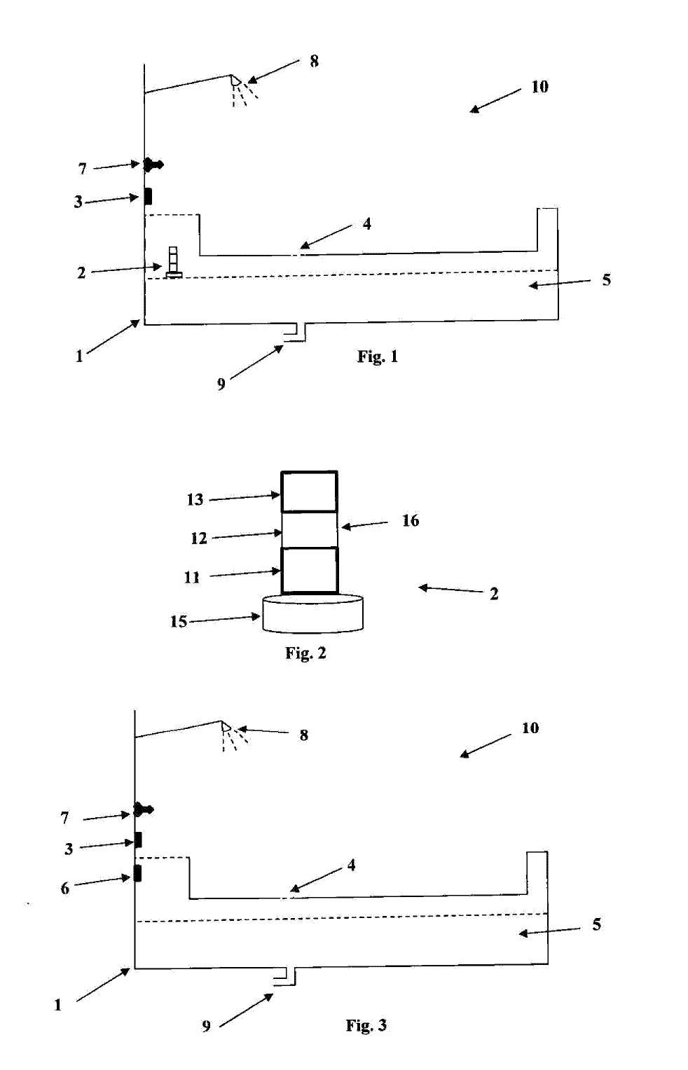

Referring to FIG. 1, the water conservation system for limiting water consumption during showering, the consumption levels being determined based on accepted international consumption standards. The system 10 features a layered/hollow bathtub 1 designed to include: a water drainage 4 attached to the upper surface of the hollow bathtub 1 for directing the consumed water to a water collecting reservoir 5, a floatable, manual indicator 2 housed in the water collecting reservoir 5 for indicating the amount of consumed water for the user and a waste water drainage outlet 9 attached to the lower base of the collecting reservoir 5.

Referring to FIG. 2, the floatable manual indicator 2 has a floatable base 15 attached to a vertical indicator bar 16 which has three different colors (red 13, yellow 12, and green 11) to indicate the amount of water consumed during showering.

During the showering, the user open the water valve 7 allowing water go through a shower head 8, the waste water go through the drainage 4 to be collected in the water collecting reservoir 5. The collected water level is raised up carrying the floatable indicator 2 upward measuring level of water consumed. While the green indicator 11 referring to the lowest international consumption, yellow indicator 12 indicating highest international consumption and red indicator 13 referring to highest local consumption. The indicator 2 has a transmitter (not shown in figures) for send a control message to control unit 3 for shutting off automatically the water valve 7 when the consumption rate is very high and the indicator red 13 is activated.

Another embodiment of the invention, the system 10 features a layered/hollow bathtub 1 designed to include: a water drainage 4 attached to the upper surface of the hollow bathtub 1 for directing the consumed water to a water collecting reservoir 5, a digital indicator or sensor 6 positioned in the bathtub's vertical one side wall of the water collecting reservoir 5 for indicating the amount of consumed water for the user and a waste water drainage outlet 9 attached to the lower base of the collecting reservoir 5.

When the consumed water level raised up and reaches the sensor 6, it reaches the highest level of consumption and so the sensor 6 sends a control message to the control unit 3 to shut off the water valve 7 automatically. The connection between the sensor 6 and the control unit maybe wireless or wired.

Another embodiment of the invention, the system 10 features a layered/hollow bathtub 1 designed to include: a water drainage 4 attached to the upper surface of the hollow bathtub 1 for directing the consumed water to a water collecting reservoir 5, a flow rate sensor (not shown in the figures) housed in the water drainage 4 and a waste water drainage outlet 9 attached to the lower base of the collecting reservoir 5. The flow rate sensor count the consumed water and send wireless message to the control unit 3 to indicate an alarm by sound or light indication to the user. The control unit may have any microcontroller, a transceiver, speaker, and light indicator LED.

It is to be understood that the present invention is not limited to the embodiments described above, but encompasses any and all embodiments within the scope of the following claims.

I claim:

1. A water conservation system for limiting water consumption during showering, wherein said system comprising:
a layered/hollow bathtub having a reservoir for collecting water, a consumed water drainage attached to the upper surface of the water collecting reservoir directing consumed water inside the water collecting reservoir, a floatable, manual indicator housed in the water collecting reservoir for indicating the amount of consumed water for the user and a waste water drainage outlet attached to the lower base of the collecting reservoir;
a water valve attached to the wall for directing showering water to the shower head; and
a control unit connected to the water valve for controlling shutoff the water valve automatically upon receiving control signal from a transmitter housed in the manual indicator when the water consumption reach the highest level.

2. The water conservation system for limiting water consumption during showering according to claim 1, wherein the floatable manual indicator having a floatable base attached to a vertical indicator bar having three different colors indicator: red, yellow, and green indicating the amount of water consumed during.

3. The water conservation system for limiting water consumption during showering according to claim 2, wherein the green indicator referring to the lowest international consumption, the yellow indicator indicating highest international consumption and the red indicator referring to highest local consumption.

4. The water conservation system for limiting water consumption during showering according to claim 2, wherein the floatable manual indicator having a transmitter sending a control message to the control unit shutting off the water valve automatically when the consumption rate is very high and the indicator red is activated.

5. A water conservation system for limiting water consumption during showering, wherein said system comprising:
a layered/hollow bathtub having a reservoir for collecting water, a water drainage attached to the upper surface of the water collecting reservoir directing consumed water inside the water collecting reservoir, a digital indicator positioned in the bathtub's vertical one side wall of the water collecting reservoir indicating the amount of consumed water for the user and a waste water drainage outlet attached to the lower base of the collecting reservoir;
a water valve attached to the wall for directing showering water to the shower head; and
a control unit connected to the water valve for controlling shutoff the water valve automatically upon receiving control signal from the digital indicator when the water consumption reach the highest level.

6. A water conservation system for limiting water consumption during showering, wherein said system comprising:
a layered/hollow bathtub having a reservoir for collecting water, a water drainage attached to the upper surface of the water collecting reservoir directing consumed water inside the water collecting reservoir, a flow rate sensor housed in the water drainage indicating the amount of consumed water for the user and a waste water drainage outlet attached to the lower base of the collecting reservoir,
a water valve attached to the wall for directing showering water to the shower head; and
a control unit connected to the water valve for controlling shutoff the water valve automatically upon receiving control signal from the flow rate sensor when the water consumption reach the highest level.
